(19) United States
(12) Patent Application Publication
(10) Pub. No.: US 2005/0182950 A1
(43) Pub. Date: Aug. 18, 2005

(54) Network security system and method

(75) Inventors: So-Ra Son, Gyeonggi-Do (KR); Yeon-Sik Ryu, Gyeonggi-Do (KR); Seung-Jong Pyo, Seoul (KR); Sang-Woo Lee, Incheon (KR); O-Young Hong, Seoul (KR)

Correspondence Address: BIRCH STEWART KOLASCH & BIRCH, PO BOX 747, FALLS CHURCH, VA, 22040-0747, US

(73) Assignee: LG N-Sys Inc., Seoul (KR)

(21) Appl. No.: 10/962,560

(22) Filed: Oct. 13, 2004

(30) Foreign Application Priority Data
Feb. 13, 2004 (KR) 2004-9684

(51) Int. Cl. H04L 9/32

(52) U.S. Cl. 713/189

(57) ABSTRACT

Disclosed herein is a network security system and method. The network security system includes a packet-dedicated processor for primarily performing hardware filtering on static attacks of network traffic, and a host system provided with a software filter for secondarily performing software filtering on dynamic attacks of network traffic. In the network security method, hardware filtering is performed on static network traffic attacks, software filtering is performed on dynamic network traffic attacks based on an analysis the results of the hardware filtering and packet streams generated by incoming packets for a predetermined time, and intrusion prevention information is provided to an administrator based on the accumulation and an analysis of the results of the software filtering.

### BACKGROUND OF THE INVENTION

1. Field of the Invention

The present invention relates generally to a network security system and method and, more particularly, to a network security system and method, which is provided with an application specific integrated circuit-based packet-dedicated processor for detecting and blocking network traffic attacks so as to process network traffic without loss at high speeds, so that the system and method can perform hardware filtering on the network traffic attacks, analyze traffic for a predetermined time and perform hardware filtering on dynamic attacks, such as denial of service attacks, and provide attack prevention information based on accumulated traffic statistical information.

2. Description of the Related Art

In general, to prevent network traffic attacks, firewalls are installed in individual hosts, or a software or hardware-based prevention system is installed to prevent attacks on a network in advance at a gateway level.

In the case of an L7 application switch that is installed to prevent network traffic attacks, specific attacks are prevented in such a way as to analyze the attacks, the patterns of which are exposed, using a content filtering function.

Conventional gateway-level software and hardware-based blocking systems include a structure, in which a general purpose network card divided into internal and external networks are mounted, network traffic attacks are blocked by processing network packets in a software manner, and related information is transmitted to an administrator, and a structure, in which a general purpose system and embedded hardware installed with a separate Operating System (OS) are connected to each other via a Peripheral Component Interconnect (PCI) interface, the embedded hardware blocks or passes high-speed traffic, and the general purpose system performs functions, such as a function of issuing an alarm to an administrator, other than the principal functions of the embedded hardware.

The firewall installed in each host performs a function of passing or blocking network packets, which are being transmitted to the host, based on access control policies. The firewall aims to prevent unauthorized users from accessing a network, using or disturbing computer resources, or leaking important information out.

The software-based blocking system performs a function of passing or blocking packets, which are input from a network card, using a software engine for performing detection and blocking based on security rules. The hardware-based blocking system allows an engine for detection and blocking to be implemented on an embedded system having a separate OS, memory and a Central Processing Unit (CPU). The hardware-based blocking system performs the above-described security function, and causes related information to be processed by a general purpose computer while communicating with the general purpose computer.

The L7 application switch can defend against attacks by performing pattern matching on the data parts of packets, which are passing through the L7 application switch, and blocking packets that are determined to be attack packets.

The host-based firewall is problematic in that it becomes more difficult for an administrator to manage the firewall, in proportion to the scale of a network. The software-based blocking system is problematic in that the rate of blocking of attacks is reduced when a traffic attack occurs because the rate of processing of traffic is reduced by loads imposed on the system in proportion to the increase in traffic.

The L7 application switch is defective in that a performance reduction and an equipment crash may occur during content filtering.

In the hardware-based blocking system, functions, other than a principal blocking function that is performed on the embedded system, are performed on a Windows OS-based general purpose computer. The hardware-based blocking system is not sufficiently adequate to an environment in which a plurality of blocking systems must be integrally managed on a large scale network. Furthermore, the direct coupling of the embedded system to the general purpose system causes the stability of operations, other than a blocking operation, of the general purpose computer to directly affect the blocking function of the embedded system.

Network traffic attacks may be classified into two types: attacks whose attack characteristics can be detected by examining unit packets, and attacks that can be detected by analyzing continuous packet streams. Since the above-described conventional network security systems simultaneously perform examinations of packet streams and unit packets, delay in the transmission of packets is caused. The embedded system, in which the CPU, the ROM and the RAM are principal components, has a limitation in real-time/entire traffic processing because software operations are required to determine whether intrusion occurs.

Furthermore, the conventional security technology employs a dedicated board for evaluating attacks based on an examination of a unit packet, but the dedicated board is problematic in that it is not accompanied by a separate CPU/Read Only Memory (ROM)/Random Access Memory (RAM)-based software operation to process real-time/entire traffic.

### SUMMARY OF THE INVENTION

Accordingly, the present invention has been made keeping in mind the above problems occurring in the prior art, and an object of the present invention is to provide a network security system and method for performing abnormal-traffic analysis and blocking using integrated software and hardware processing, which is installed on a network in a high-capacity traffic environment, such as a gigabit network, in in-line mode, detects and blocks a multi-stage attack on the network in real time based on filtering techniques, and transmits related information to an administrator in real time.

In order to accomplish the above object, the present invention provides a network security system, including a packet-dedicated processor for primarily performing hardware filtering on static attacks of network traffic; and a host system provided with a software filter for secondarily performing software filtering on dynamic attacks of network traffic.

In this case, the hardware filtering is performed by performing pattern matching on incoming packets based on defined security rules, the software filtering is performed by selectively transmitting processing results of the packet-dedicated processor to the software filter and analyzing packet streams that are generated for a predetermined time. The processing results of the packet-dedicated processor include information on blocking results related to packets incoming to the packet-dedicated processor, information on packets primarily filtered out by the packet-dedicated processor, information on all the packets incoming to the packet-dedicated processor and header information of all packets.

The network security system further includes a remote management system for creating security rules that will be applied to the packet-dedicated processor and the software filter and transmitting the security rules on-line; and a network traffic analysis system for receiving network traffic information from the packet-dedicated processor and the software filter, accumulating and analyzing the network traffic information, and providing intrusion prevention information to an administrator.

A network security system according to another embodiment of the present invention includes a blocking system connected to a gateway of a network in transparent mode to block traffic attacks on the network; a remote management system for creating security rules that will be applied to the packet-dedicated processor and the software filter and transmitting the security rules on-line; and a network traffic analysis system for receiving network traffic information from the packet-dedicated processor and the software filter, accumulating and analyzing the network traffic information, and providing intrusion prevention information to an administrator.

In this case, the blocking system includes a packet-dedicated processor for primarily performing hardware filtering on static attacks of network traffic; and a host system provided with a software filter for secondarily performing software filtering on dynamic attacks of network traffic.

A network security method according to the present invention includes the steps of performing hardware filtering on static network traffic attacks; performing software filtering on dynamic network traffic attacks based on an analysis of results of the hardware filtering and packet streams generated by incoming packets for a predetermined time; and providing intrusion prevention information to an administrator based on accumulation and an analysis of results of the software filtering.

The method further includes the step of transmitting information on setup of static security rules and dynamic security rules, data management of block logs, and other security management on-line.

The step of performing hardware filtering includes the steps of receiving packets from a network and a gateway; analyzing header and contents information of the packets based on set security rules in real time; and searching for and blocking packets, which violate the security rules, in real time regardless of packet shape and size.

The step of performing software filtering includes the steps of receiving results of the hardware filtering and packet information; issuing an alarm to the administrator using the results of the hardware filtering and performing dynamic attack filtering using the packet information; and transmitting results of the dynamic attack filtering results to the remote management system.

The dynamic attack filtering is performed by accumulating the packet information and analyzing a variation of traffic for a predetermined time based on predefined dynamic attack security rules and scheduled blocking rules, and transmitting the blocking rules to a countermeasure management module to be transmitted to a packet-dedicated processor if it is determined that the traffic is abnormal traffic and exceeds a threshold value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing the construction of a network equipped with a network security system according to the present invention;

FIG. 2 is a block diagram showing the construction of the blocking system of FIG. 1;

FIG. 3 is a block diagram showing a functional flow between the internal modules of a software filter provided in the host system of FIG. 2;

FIG. 4 is a block diagram showing the construction of the remote management system of FIG. 1; and

FIG. 5 is a block diagram showing the construction of the network traffic analysis system of FIG. 1.

### DESCRIPTION OF THE PREFERRED EMBODIMENTS

Reference now should be made to the drawings, in which the same reference numerals are used throughout the different drawings to designate the same or similar components.

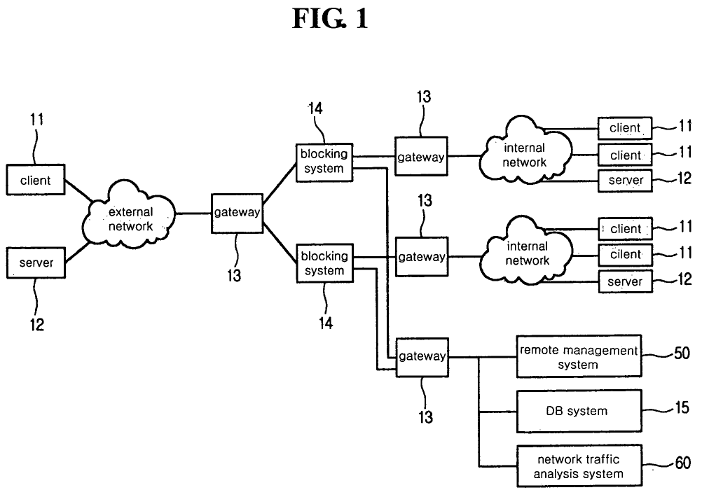

FIG. 1 is a diagram schematically showing the construction of a network equipped with a network security system according to the present invention.

Referring to FIG. 1, a client 11 and a server 12 connected to the Internet, that is, an external network, exist, and an abnormal traffic analysis/blocking system (hereinafter referred to as a “blocking system”) 14 is connected to the gateway 13 of an internal network for providing protection to prevent an existing network environment from being changed in transparent mode so as to block a traffic attack incoming from the external network to the internal network.

The blocking system 14 performs real-time attack detection and blocking on all the communication traffic between hosts that exist on the internal network, and hosts that are connected to the Internet, and transmits results to a management console, that is, a remote management system 50.

The blocking system 14 includes a packet-dedicated processor implemented using a PCI type card and a host system equipped with the packet-dedicated processor. The blocking system 14 sequentially performs hardware filtering and software filtering on traffic attacks through the packet-dedicated processor and the host system.

The remote management system 50 can create security rules that will be applied to the blocking system 14, and may transmit and apply the security rules to the blocking system 14 on-line.

The blocking system 50 is equipped with a separate network interface card for communicating with the remote management system 50 so that the remote management system 50 can simultaneously and integrally manage the plurality of blocking systems 14.

The construction and operation of the network security system according to the present invention are described in detail below.

The blocking system 14 includes the packet-dedicated processor that is implemented using a card based on a network interface, and a Static RAM (SRAM) and a PCI interface for loading static rules, that is, information on countermeasures against attacks, so that the blocking system 14 can primarily filter out static network traffic attacks through the packet-dedicated processor.

Processing results, including information on blocking results related to incoming packets, information on packets primarily filtered out by the packet-dedicated processor, information on all the packets incoming to the packet-dedicated processor and partial information of packets according to a specific condition, are selectively transmitted to a software filter provided in the host system of the blocking system, packet streams generated for a predetermined time are analyzed using the processing results, and dynamic attacks, such as Denial of Service (DoS) attacks, are secondarily filtered out.

That is, in the blocking system 14, the packet-dedicated processor for performing traffic attack detection and blocking is implemented using an Application Specific Integrated Circuit (ASIC). The blocking system 14 performs primary hardware filtering on static network traffic attacks by receiving network packets and performing pattern matching on the network packets based on defined rules (static security rules). The blocking system 14 performs secondary software filtering on dynamic attacks by selectively transmitting processing results, including information on blocking results related to incoming packets, information on packets primarily filtered out by the packet-dedicated processor, information on all the packets incoming to the packet-dedicated processor and partial information of packets according to a specific condition (for example, header information of all the packets) to the software filter and analyzing packet streams, which are generated for a predetermined time, using the processing results.

In this case, the static attacks are attacks whose attack characteristics can be detected using only collected unit packets, like a signature-based attack, and the dynamic attacks are attacks that can be detected by analyzing packet streams collected for a predetermined time, like a DoS attack or an anomaly attack.

The network traffic information obtained through the blocking system 14 is transmitted to a separate network traffic analysis system 60, and the network traffic analysis system 60 accumulates and analyzes the information and provides intrusion prevention information to an administrator.

In this case, the network traffic analysis system 60 is a system that may be installed on the remote management system 50 or may be operated independently.

A management function for managing blocking log data, setting static security rules and dynamic security rules, setting up the environments for the packet-dedicated processor and the software filter, and other security management functions is implemented in a structure capable of being remotely connected using socket communications under a Transmission Control Protocol/Internet Protocol (TCP/IP) environment by the remote management system 50, so that a large-scale integrated environment can be constructed.

The blocking system 14 receives blocking log information, stores it in a DataBase (DB) and performs a secondary alarm function by transmitting blocking log information to the administrator via e-mail or Short Message Service (SMS).

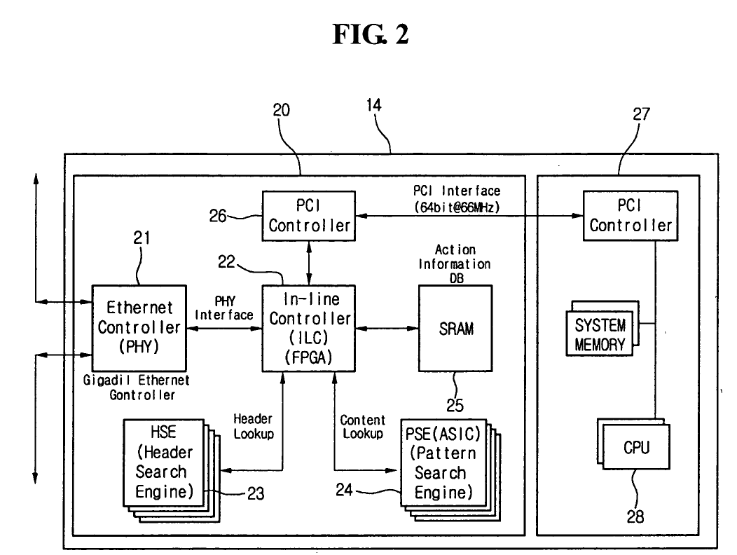

FIG. 2 is a block diagram showing the construction of the blocking system of FIG. 1.

Referring to FIG. 2, the blocking system includes the packet-dedicated processor 20 for primarily performing hardware filtering on static network traffic attacks and the host system 27 for secondarily performing software filtering on dynamic network traffic attacks (for example, a DoS attack).

The packet-dedicated processor 20 is equipped with a large-size traffic processing-dedicated Pattern Search Engine (PSE) 24 that is formed of an ASIC, and can process bi-directional 2 Gbps traffic in real time regardless of packet size in in-line mode in a gigabit environment.

On the basis of such packet processing capability, the packet-dedicated processor 20 stably and transparently processes packets regardless of packet shape and size in such a way as to analyze the header information and contents of packets in real time based on set security rules and detect and block packets that violates the security rules.

The Ethernet controller (hereinafter referred to as a “PHY”) 21 of the packet-dedicated processor 20 causes a gigabit line interface to input packets and allows the packets to be processed by an In-Line Controller (ILC) 22, and performs the Layer-2 function. Furthermore, the Ethernet controller 21 functions to output packets, which have been input to the packet-dedicated processor 20 and processed inside of the packet-dedicated processor 20, to a line.

The ILC 22 analyzes packets input from the PHY 21, transmits header information and contents, that is, patterns, to a Header Search Engine (HSE) 23 and a Pattern Search Engine (PSE) 24, respectively, and forwards the packets using analysis results obtained in the two engines, that is, the HSE 23 and the PSE 24.

The setup information of internal blocks, such as the PSE 24 and the HSE 23, that has been transmitted from the remote management system 50 through the host system 27 and the PCI controller 26, is transmitted to the corresponding blocks (PSE 24 and HSE 23), and the information, including packet processing results, is transmitted to the host system 27 through the PCI controller 26.

In the above case, the PCI controller 26 in charge of the communication of the packet-dedicated processor 21 and the host system 27 is a data transmission path to and from the host system 27. The PCI controller 26 receives information from the remote management system 50 through the host system 27 so as to set search conditions that will be used in the PSE 24 and the HSE 23, and information that will be used in a SRAM (action info DB) 25. Furthermore, the PCI controller 26 is used as a transmission path for reporting processing results and status by transmitting data on packet processing results and statistical information to the remote management system 50 through the host system 27.

The PSE 24 formed of an ASIC receives search conditions (that is, comparison information used to determine whether incoming packets are normal or not) from the remote management system 50 and stores them, and the SRAM 25 receives information on countermeasures against network traffic attacks (information used to determine whether to block or pass filtered packets) and stores it.

The PSE 24, which is a principal element for packet analysis and has blocking logic with respect to traffic attacks, is formed of an ASIC, allows the search conditions, which are transmitted from the remote management system 50 through the ILC 22, to be set therein, searches contents based on the search conditions, and transmits search results to the ILC 22.

The HSE 23 searches the headers of packets based on the values set by the ILC 22, and transmits search results to the ILC 22.

The SRAM 25 of the packet-dedicated processor 20 is a DB that has processing methods corresponding to the packet search results. The SRAM 25 allows the countermeasure information, which is transmitted from the remote management system 50 through the ILC 22, to be stored therein, and transmits processing methods corresponding to the packet search results to the ILC 22.

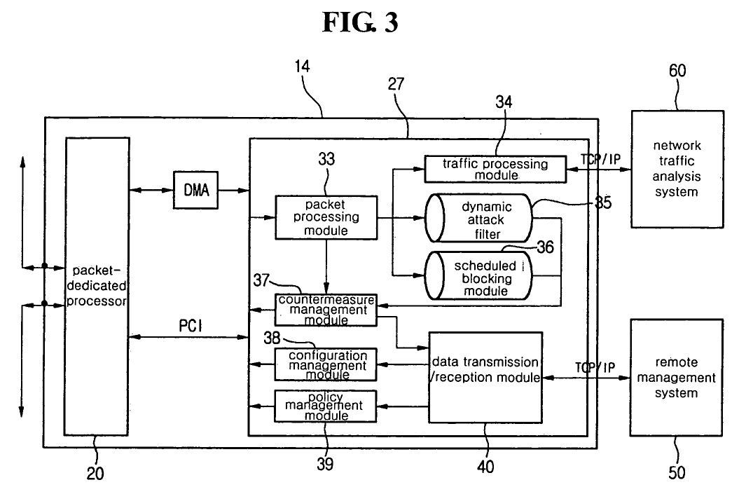

FIG. 3 is a block diagram showing a functional flow between the internal modules of a software filter provided in the host system of FIG. 2.

In this case, the software filter performs software filtering on dynamic network traffic attacks, and performs dynamic attack detection and other security functions in the CPU of the host system 28 of FIG. 2.

The dynamic attack filtering function, which is a principal function of the software filter, is descried below.

The packet processing module 33 selectively receives processing results, including information on blocking results with respect to incoming packets, packets primarily filtered out in the packet-dedicated processor, all packets incoming to packet-dedicated processor and the partial information of packets based on set conditions, from the packet-dedicated processor 20 through a Direct Memory Access (DMA) memory region, and transmits blocking result information to a countermeasure management module 37 to allow an administrator alarm function to be performed therein, and transmits the packet information to a dynamic attack filter 35 and a scheduled blocking filter 36 to allow dynamic attack filtering to be performed therein.

In that case, the packet processing module 33 can selectively receive processing results, including “information on blocking results with respect to incoming packets, packets primarily filtered out in the packet-dedicated processor, all packets incoming to packet-dedicated processor and the partial information of packets based on set conditions, from the packet-dedicated processor 20 according to the user's setting.

The packet processing module 33 transmits traffic information to the traffic processing module 34, so that statistical information can be transmitted to the network traffic analysis system 60

The dynamic attack filter 35 and the scheduled blocking filter 36 analyze traffic for a specific time using input packet information based on predefined dynamic attack security rules and scheduled blocking rules. If it is determined that the traffic is abnormal traffic and exceeds a threshold value, the blocking rules are transmitted to the countermeasure management module 37 to be transmitted to the packet-dedicated processor 20, so that the packet-dedicated processor 20 can block abnormal traffic. That is, blocking rules are made to be added to the packet-dedicated processor 20.

The countermeasure management module 37 transmits blocking result information, which is received from the packet-dedicated processor 20, to a data transmission/reception module 40 to notify the administrator of the blocking result information. The data transmission/reception module 40 transmits the blocking result information to the remote management system 50 through the TCP/IP socket.

The data transmission/reception module 40 receives security rules and configuration management information that are defined by the remote management system 50, and transmits the security rules and the configuration management information to a configuration management module 38 and a policy management module 39, in addition to the function of notifying the administrator of the blocking result information. The configuration management module 38 and the policy management module 39 performs a function of causing the packet-dedicated processor 20 and the software filter 30 to apply the security rules and the configuration management information thereto.

The data transmission/reception module 40 has a function of performing mutual communication authentication between the remote management system 50 and the blocking system 14 provided with the packet-dedicated processor and the host system.

The configuration management module 38 performs functions related to the state initialization and drive mode of the packet-dedicated processor 20. The policy management module 39 downloads static security rules, which are criteria for performing detection/blocking on the packet-dedicated processor 20, through the PCI interface 26 of FIG. 2, and performs an on-line policy changing function in real time.

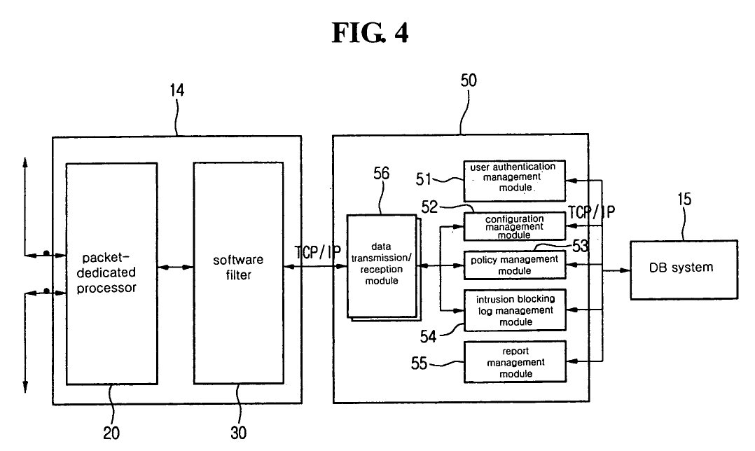

FIG. 4 is a block diagram showing the construction of the remote management system of FIG. 1.

FIG. 4 shows the components of the remote management system 50 that manages the function of notifying the administrator of the blocking information generated in a blocking system 14, and all configuration management information including a security policy for operating the blocking system 14.

The main function of a remote management system 50 is to notify the administrator of blocking logs, which are generated in the blocking system 14, through a data transmission/reception module 56, and to allow all the blocking logs, which are received from a plurality of blocking systems 14, to be integrally managed. Additionally, the remote management system 50 performs a function of transmitting the configuration management information and blocking related security rules of the blocking system to the blocking system and causing the information and the rules to be applied to the blocking system.

Referring to FIG. 4, the data transmission/reception module 56 stores received log information in a DB system 15 through an intrusion blocking log management module 54, and performs a function of applying the configuration management information of the blocking system 14, which is defined by a configuration management module 52, and blocking-related security rules, which are defined by a policy management module 53, to the blocking system 14.

The data transmission/reception module 56 has a function of performing mutual communication authentication between the remote management system 50 and the blocking system 14.

The policy management module 53 performs a function of defining rules for filtering out static attacks on a packet-dedicated processor 20 of the blocking system 14, and performs functions of defining rules for filtering out dynamic attacks on the software filter 30 of the CPU 28 (FIG. 2) of the host system, and scheduled filtering rules.

A user authentication management module 51 manages the user authentication information of the remote management system and the blocking system 14, and performs a user authentication function to allow access only to the authorized users of the remote management system 50.

A report management module 55 provides formalized reports on statistical information and blocking logs to the administrator using blocking information accumulated in the DB system.

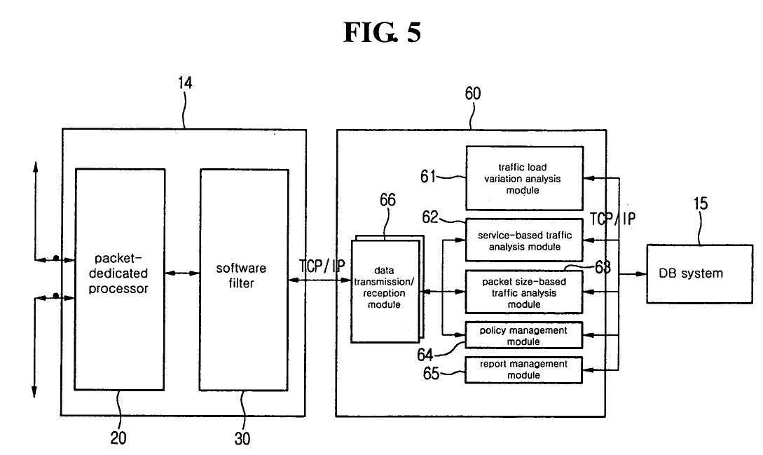

FIG. 5 is a block diagram showing the construction of the network traffic analysis system of FIG. 1.

FIG. 5 shows the components of the network traffic analysis system 60 for receiving traffic information from the blocking system 14 and analyzing the variation of traffic.

Referring to FIG. 5, a data transmission/reception module 66 receives traffic information from a blocking system 14, stores the traffic information in a DB system 15, and transmits the traffic information to a traffic load variation analysis module 61, thus providing information on a real-time variation to the administrator.

Furthermore, a service-based traffic analysis module 62 and a packet size-based analysis module 63 provide traffic distribution information to the administrator using accumulated traffic information.

The network traffic analysis system 60 is provided with a policy management module 64 to analyze abnormal traffic that may be generated by unknown attacks. The network traffic analysis system 60 establishes rules for distinguishing abnormal traffic from normal traffic, analyzes abnormal traffic and provides abnormal traffic analysis information to the administrator, thus preventing attacks.

A report management module 65 provides formalized reports on statistical information and abnormal traffic related information to the administrator using traffic information accumulated in the DB system 15.

In this case, the network traffic analysis system 60 is a system that may be installed on the remote management system 50 or may be operated independently.

The network security system according to the present invention may be implemented using a PCI type card to perform attack detection and blocking functions through pattern matching. The host, in which the card is installed, takes charge of communications with the remote management system, transmits detection and blocking results to the remote management system, and transmits other traffic information to the network traffic analysis system, thus providing traffic information to the administrator in real time.

The network security system and method according to the present invention is advantageous in that attacks can be effectively prevented because packets, including attacks, can be detected and blocked in real time without the loss and delay of packets using the hardware-based packet-dedicated processor in a gigabit traffic environment, and the internal network can be safely protected from abnormal traffic because dynamic attacks other than static attacks are filtered out by the software filter installed on the general purpose computer.

Furthermore, the present invention is advantageous in that costs can be minimized because the network security system can be installed without a change in the structure of an existing network, and the network security system can be easily managed in a large-scale network environment because a plurality of blocking systems can be integrally managed at the same time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A network security system, comprising:
a packet-dedicated processor for primarily performing hardware filtering on static attacks of network traffic; and
a host system provided with a software filter for secondarily performing software filtering on dynamic attacks of network traffic.

2. The network security system as set forth in claim 1, wherein the hardware filtering is performed by performing pattern matching on incoming packets based on defined security rules.

3. The network security system as set forth in claim 1, wherein the software filtering is performed by selectively transmitting processing results of the packet-dedicated processor to the software filter and analyzing packet streams that are generated for a predetermined time.

4. The network security system as set forth in claim 3, wherein the processing results of the packet-dedicated processor comprise information on blocking results related to packets incoming to the packet-dedicated processor, information on packets primarily filtered out by the packet-dedicated processor, information on all the packets incoming to the packet-dedicated processor and header information of all packets.

5. The network security system as set forth in claim 1, further comprising a remote management system for creating security rules that will be applied to the packet-dedicated processor and the software filter and transmitting the security rules on-line.

6. The network security system as set forth in claim 1, further comprising a network traffic analysis system for receiving network traffic information from the packet-dedicated processor and the software filter, accumulating and analyzing the network traffic information, and providing intrusion prevention information to an administrator.

7. The network security system as set forth in claim 1, wherein the packet-dedicated processor comprises:
an Ethernet controller (PHY) for inputting/outputting packets to/from a network and a gateway;
an In-Line Controller (ILC) for analyzing the packets input from the PHY, transmitting header information to a Header Search Engine (HSE) and contents to a Pattern Search Engine (PSE), and detection and blocking packets, which violate the security rules, based on analysis results obtained in the HSE and the PSE;
the PSE for performing content search based on values set by the ILC and transmitting results of the search to the ILC;
the HSE for performing packet header search based on values set by the ILC and transmitting the results of the search to the ILC;
Static Random Access Memory (SRAM, action info Database) for storing processing methods corresponding to the results of the search, and transmitting a processing method, which corresponds to the results of the search input from the ILC, to the ILC; and
a Peripheral Component Interconnect (PCI) controller for receiving information to set search conditions, which will be used in the PSE and the HSE, and information, which will be used in the SRAM, from the host system, and reporting processing results and status by transmitting the packet processing results and statistical information data to the host system.

8. The network security system as set forth in claim 7, wherein the PSE is formed of an Application Specific Integrated Circuit (ASIC) and stores the search conditions for searching incoming packets.

9. The network security system as set forth in claim 8, wherein the search conditions are comparison information for determining whether the incoming packets are normal packets or not.

10. The network security system as set forth in claim 7, wherein the SRAM stores information on countermeasures against network traffic attacks.

11. The network security system as set forth in claim 10, wherein the countermeasure information includes information for determining whether to pass or block the packets filtered in the packet-dedicated processor.

12. The network security system as set forth in claim 1, wherein the software filter provided on the host system comprises:
a packet processing module for receiving blocking result information and packet information from the packet-dedicated processor through a Direct Memory Access (DMA) memory region, and a countermeasure management module for receiving blocking result information from the packet processing module and issuing an alarm to an administrator;
a dynamic attack filter for receiving packet information from the packet processing module and performing dynamic attack filtering and a scheduled blocking filter;
a traffic processing module for transmitting information, which is received from the packet processing module to analyze traffic attacks, to the network traffic analysis system;
a countermeasure management module for transmitting the blocking result information to a data transmission/reception module to notify the administrator of the blocking result information;
the data transmission/reception module for transmitting results to the remote management system through a Transmission Control Protocol/Internet Protocol (TCP/IP) socket;
a configuration management module for performing functions of status initiation of the packet-dedicated processor and drive mode; and
a policy management module for downloading static security rules that are detection and blocking criteria on the packet-dedicated processor and performing an on-line policy changing function in real time.

13. The network security system as set forth in claim 12, wherein the data transmission/reception module receives security rules and configuration management information defined by the remote management system, and transmits the security rules and the configuration management information to the configuration management module and the policy management module.

14. The network security system as set forth in claim 12, wherein the packet processing module selectively receives information on blocking results related to packets incoming to the packet-dedicated processor, information on packets primarily filtered out by the packet-dedicated processor, information on all the packets incoming to the packet-dedicated processor and header information of all packets from the packet-dedicated processor as processing results according to a user's setting.

15. The network security system as set forth in claim 12, wherein the dynamic attack blocking filter and the scheduled blocking filter accumulate input packet information and analyze the variation of traffic based on previously defined dynamic attack security rules and scheduled blocking rules, and transmit the block rules to the countermeasure management module to be transmitted to the packet-dedicated processor if the traffic is determined to be abnormal traffic and exceeds a threshold value.

16. The network security system as set forth in claim 5, wherein the remote management system comprises:
a data transmission/reception module for receiving log information from a blocking system;
an intrusion blocking log management module for transmitting the received log information to a database system to be stored therein;
a configuration management module for defining configuration management information for the blocking system;
a policy management module for defining blocking related security rules for the blocking system; and
a report management module for providing formalized reports on statistical information and blocking logs to the administrator using blocking information accumulated in the database system.

17. The network security system as set forth in claim 16, wherein the policy management module defines filtering rules for statistic network traffic attacks and filtering rules for dynamic network traffic attacks.

18. The network security system as set forth in claim 16, wherein the remote management system further comprises a user authentication management module for managing user authentication information of the remote management system and the blocking system and performing a user authentication function to allow access only to authorized users of the remote management system.

19. The network security system as set forth in claim 6, wherein the network traffic analysis system comprises:
a data transmission/reception module for receiving traffic information from the blocking system, and storing the traffic information in a database system;
a service-based traffic analysis module or packet size-based traffic analysis module for providing traffic distribution information to an administrator using accumulated traffic information;
a policy management module for analyzing abnormal traffic that may be generated by unknown attacks; and
a report management module for providing formalized reports on statistical information and abnormal traffic-related information to the administrator using the traffic information accumulated in the database system.

20. The network security system as set forth in claim 19, wherein the policy management module establishes rules for distinguishing the abnormal traffic from normal traffic, analyzes the packets and notifies the administrator of abnormal traffic related information.

21. The network security system as set forth in claim 19, further comprising a traffic load variation analysis module for providing a real-time variation of the traffic information transmitted from the blocking system to the administrator.

22. A network security system, comprising:
a blocking system connected to a gateway of a network in transparent mode to prevent traffic attacks on the network;
a remote management system for creating security rules to be applied to the blocking system and transmitting the security rules to the blocking system on-line; and
a network traffic analysis system for receiving network traffic information from the blocking system, accumulating and analyzing the network traffic information, and proving intrusion prevention information to an administrator.

23. A network security method, comprising the steps of;
performing hardware filtering on static network traffic attacks;
performing software filtering on dynamic network traffic attacks based on an analysis of results of the hardware filtering and packet streams generated by incoming packets for a predetermined time; and
providing intrusion prevention information to an administrator based on accumulation and an analysis of results of the software filtering.

24. The method as set forth in claim 23, further comprising the step of transmitting information on setup of static security rules and dynamic security rules, data management of block logs, and other security management on-line.

25. The method as set forth in claim 23, wherein the step of performing hardware filtering comprises the steps of:
receiving packets from a network and a gateway;
analyzing header and contents information of the packets based on set security rules in real time; and
searching for and blocking packets, which violate the security rules, in real time regardless of packet shape and size.

26. The method as set forth in claim 23, wherein the step of performing software filtering comprises the steps of:
receiving results of the hardware filtering and packet information;
issuing an alarm to the administrator using the results of the hardware filtering and performing dynamic attack filtering using the packet information; and
transmitting results of the dynamic attack filtering results to the remote management system.

27. The method as set forth in claim 26, wherein the dynamic attack filtering is performed by accumulating the packet information and analyzing a variation of traffic for a predetermined time based on predefined dynamic attack security rules and scheduled blocking rules, and transmitting the blocking rules to a countermeasure management module to be transmitted to a packet-dedicated processor if it is determined that the traffic is abnormal traffic and exceeds a threshold value.
